(19) United States
(12) Patent Application Publication
(10) Pub. No.: US 2004/0219379 A1
(43) Pub. Date: Nov. 4, 2004

(54) Electrophotographic recording sheet

(75) Inventors: Taketo Okutani, Yokohama-shi (JP); Kanako Inaki, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: OJI PAPER CO., LTD., Tokyo (JP)

(21) Appl. No.: 10/832,308

(22) Filed: Apr. 27, 2004

(30) Foreign Application Priority Data
Apr. 30, 2003 (JP) 2003-125643
Mar. 19, 2004 (JP) 2004-80281

(51) Int. Cl. B32B 27/06

(52) U.S. Cl. 428/480; 428/500

(57) ABSTRACT

An electrophotographic recording sheet comprising a layer, on at least one surface thereof, which contains at least one resin selected from the group consisting of amino group-containing acrylic-based resins, rosin ester-based resins, styrene/acrylic-based resins and styrene/maleic-based resins, olefin/acrylic-based resins and olefin/maleic acid-based resins. The electrophotographic recording sheet has a satisfactory toner fixing property, does not exhibit notable yellowing when subjected to a prolonged storage or heat treatment, produces excellent recorded images, and facilitates waste paper recovery and recycling.

### FIELD OF THE INVENTION

The present invention relates to an electrophotographic recording sheet, for use in a wet electrophotographic system, which has a satisfactory toner fixing property, does not exhibit any notable yellowing when subjected to a prolonged storage or heat treatment, and can be recycled easily.

### PRIOR ART

Offset printing, gravure printing and the like have been employed as methods for mass copying of data such as characters and images. Such printing methods are excellent methods for mass copying an identical data, but are unsuitable for copying various data in small amounts.

Ink jet printers and copy machines have been most commonly employed for electroprinting methods used in low volume printing. Electroprinting methods include thermographic systems, electrophotographic systems, ink jet systems, thermal transfer systems and the like, and printers and copying machines have been developed which utilize such systems. Ink jet systems and electrophotographic systems are employed particularly for inexpensive copying. However, ink jet systems are inferior in terms of light fastness and moisture resistance due to the use of dye inks comprising dyestuffs as coloring materials, while another disadvantage is that they require special sheets provided with ink receiving layers. In order to accomplish requirements such as high quality, high speed and economy, electrophotographic systems are most preferred.

Electrophotographic systems may be either dry or wet systems. Dry electrophotographic systems include office copying machines and the like, and they employ solid powder toners comprising pigments and synthetic resins as the image-forming toners. Image formation is accomplished by a process of adsorbing a toner onto an electro static latent image generated with corona charge, and then transferring the toner onto the recording sheet, followed by heat pressing. In this type of dry electrophotographic system, as fine the toners are, they scatter into the environment to a large extent and, thus, can become harmful when inhaled. Therefore, restrictions have been placed on the degree of fineness of solid powder toners. This results in difficulty in achieving high resolution. In addition, transfer sheets with non-uniform thicknesses tend to produce uneven charge density on the transfer sheet surfaces produced by corona discharge, resulting in numerous problems such as formation of undesirable images, so-called “fogging” at the non-image sections, or the need for carrying out fusion fixing at a relatively high temperature.

On the other hand, in wet electrophotographic systems employing liquid toner, it is possible to obtain very sharp images because the toner used can be finer than for dry electrophotographic systems. Further, as it is possible to use pigments as the coloring materials, poor light fastness or moisture resistance will not become a problem.

Wet electrophotographic systems have been studied for a long time and some systems have been developed for practical use, but they have not become generally used because of problems associated with their recording properties, the solvent odors, transferability to substrates, and the like. In recent years, however, the product E-PRINT™ by Indigo has been provided as a device which avoids many of the aforementioned disadvantages.

Recording materials used in wet electrophotographic systems include plastic films, plastic sheets, pigment coated sheets, metals and the like, and various modifications have been provided to them. When the recording material is a plastic film, plastic sheet or the like, the liquid toner often fails to permeate into the recording material, resulting in residual excess solvent (toner dispersion medium) on the recording material surface. In order to fix the toner onto the film, etc., it thus becomes necessary to remove the excess solvent, which must be accomplished by a process of heating the film, etc. to a high temperature. Even after the solvent has been removed by heating, in order to increase cohesion between the film etc. and the toner, the toner must be reheated so as to accomplish complete thermofusion of the toner resin onto the film, etc. Consequently, the plastic films or sheets that can be used at the present stage are limited to only certain types of plastic films or sheets, such as polyester resin films, which exhibit a relatively high heat resistance.

Use of pigment coated-paper sheets has also been investigated, but their use involves increased sheet thicknesses, which leads to problems such as poor toner permeability, poor toner transfer or cohesion as occurs in the case of plastic films or plastic sheets, as well as fading of prints on the printed surfaces when being printed by high-speed printing, removal of toner when rubbed with erasers, and peel-off of the paper printed sections after being contacted with cellophane adhesive tape. Paper sheet-feeding trouble is another problem in the course of continuous printing.

In order to deal with these problems, treatment of recording materials with polyethyleneimines has been proposed [Japanese Unexamined Patent Publication (Kokai) No. 8-286410, Japanese Unexamined Patent Publication (Kokai) No. 9-179329, Japanese Unexamined Patent Publication (Kokai) No. 11-119460]. Although use of polyethyleneimines can improve the toner fixing property, they result in considerable yellowing of the recording materials with heating or with the passage of time after production. Further, their strong cationic nature makes the recycling of the waste paper difficult, and the high cost of polyethyleneimines themselves is also a problem.

On the other hand, research on improving toner fixing properties involves, use of a resin which dissolves the toner-composing resins at low temperature, use of thermosetting resins in producing the toner, and the like. However, the toners produced in these manners are, in most cases, inferior in terms of stability with time and in terms of the basic properties for electrophotography, and has therefore not yet reached a level for practical use.

### DISCLOSURE OF INVENTION

It is an object of the present invention to provide an electrophotographic recording sheet which has a satisfactory toner fixing property, does not exhibit any notable yellowing when subjected to a prolonged storage or heat treatment, gives excellent recorded images, and which can also be easily subjected to waste paper-recovery or recycling treatment.

As a result of diligent research in light of the problems described above, the present inventors have discovered that amino group-containing acrylic-based resins, rosin ester-based resins, styrene/acrylic-based resins, styrene/maleic-based resins, olefin/acrylic-based resins and olefin/maleic-based resins (hereinafter also referred to as “toner fixing enhancers”) exhibit excellent liquid toner fixing enhancer effects which are equivalent or may be superior to that of polyethyleneimines, and that they exhibit no notable yellowing after being subjected to either a prolonged storage or heat treatment.

### BEST MODE FOR CARRYING OUT THE INVENTION

The electrophotographic recording sheet of the invention comprises a sheet-form substrate, at least one surface of said substrate has been subjected to a treatment so as to impart a toner-receiving ability thereto, and is characterized in that said treatment is carried out with a treatment composition comprising at least one resin selected from the group consisting of amino group-containing acrylic-based resins, rosin ester-based resins, styrene/acrylic-based resins, styrene/maleic-based resins, olefin/acrylic-based resins and olefin/maleic-based resins. Preferably, the treatment composition further comprises a styrene/butadiene-based copolymer.

According to a preferred embodiment, the treatment composition comprises at least an amino group-containing acrylic-based resin.

According to another preferred embodiment, the treatment composition comprises at least a rosin ester-based resin. In this case, the rosin ester-based resin is preferably used in combination with at least one resin selected from the group consisting of styrene/acrylic-based resins, styrene/maleic-based resins, olefin/acrylic-based resins and olefin/maleic-based resins.

According to another aspect, the electrophotographic recording sheet of the invention comprises a sheet-form substrate and a toner-receiving layer on at least one surface thereof, and is characterized in that the toner-receiving layer comprises at least one resin selected from the group consisting of amino group-containing acrylic-based resins, rosin ester-based resins, styrene/acrylic-based resins, styrene/maleic-based resins, olefin/acrylic-based resins and olefin/maleic-based resins. Preferably, the toner-receiving layer further comprises a styrene/butadiene-based copolymer.

According to a preferred embodiment, the toner receiving layer comprises at least an amino group-containing acrylic-based resin.

According to another preferred embodiment, the toner receiving layer comprises at least a rosin ester-based resin. In this case, the rosin ester-based resin is preferably used in combination with at least one resin selected from the group consisting of styrene/acrylic-based resins, styrene/maleic-based resins, olefin/acrylic-based resins and olefin/maleic-based resins.

According to yet another preferred embodiment, the electrophotographic recording sheet has at least one type of the aforementioned toner fixing enhancer on at least one side of the sheet-form substrate at a coating coverage of between 0.1 g/m² and 0.8 g/m², and preferably 0.3 g/m² and 0.5 g/m².

The electrophotographic recording sheet coated with a toner fixing enhancer according to the invention is an excellent recyclable electrophotographic recording sheet with a superior toner fixing property, no notable yellowing and no tendency to create sheet-feeding trouble.

The sheet-form substrate of the electrophotographic recording sheet of the invention may be made of any material so long as it possesses on its surface a treatment composition or a toner receiving layer comprising the aforementioned toner fixing enhancer as the principle components. There may be used various paper substrates, or resin materials such as plastic films or sheets, which essentially do not affect the fixing property of the toner to the sheet-form substrate itself. However, a paper substrate is preferred from the standpoint of recovery and recycling.

When the sheet-form substrate of the invention is a paper substrate, the pulp fiber used may be a wood fiber from hardwood or softwood. The pulping method is not critical and may involve one or more delignification stages for unbleached pulp obtained by a digestion process such as kraft digestion, polysulfide digestion, sulfurous acid digestion or the like, followed by a multistage bleaching process accomplished with appropriate addition of chlorine, caustic soda, hydrosulfite or the like (for kraft pulp, sulfide pulp, etc.). However, taking account of the problem encountered with the organic chlorine compounds in waste water, it is preferred to use ECF pulp obtained from a bleaching process employing chlorine dioxide instead of chlorine, or TCF pulp obtained from a multistage bleaching process employing ozone and no chlorine-based bleaching chemicals. There may also be used mechanical pulp such as groundwood pulp (GP), thermomechanical pulp (TMP) or chemithermo-mechanical pulp (CTMP), or various types of semi-chemically processed pulps such as semi-chemical pulp (SCP) or chemigroundwood pulp (CGP). There may also be mentioned hemp pulp, kenaf pulp, bagasse pulp and the like, while recycled paper pulp may also be used in consideration of effective utilization of resources.

The appropriately selected pulp is beaten in a range of 300-500 ml CSF, and then made into paper using a Fourdrinier multicylinder paper machine, a Fourdrinier Yankee paper machine, a twin-wire paper machine, a cylinder paper machine or an inclined wire former. The present invention is not restricted in any way to the use of any particular paper machine.

An inorganic or organic filler may be used for the paper making. For example, there may be mentioned inorganic filler, such as kaolin, talc, clay, calcium carbonate, calcined clay, titanium dioxide, diatomaceous earth, fine powdered anhydrous silica, activated white clay, zinc oxide, aluminum oxide, aluminum hydroxide, zinc sulfate, barium sulfate, silicon dioxide or colloidal silica, and organic fillers such as urea-formalin resin fillers, nylon powder, polyethylene powder and the like.

There are no particular restrictions on internal or external sizing agents to be used. Examples of sizing agents which may be used include rosin-based sizing agents, alkylketene dimer-based sizing agents and alkenyl succinic anhydrides, added to a Stockigt sizing degree of at least 10 seconds. Depending on the use, a Stöckigt sizing degree of less than 10 seconds may result in problems such as writing ink. However, it is not preferably greater than 200 seconds as this may result in poor toner fixing. When an alkylketene dimer-based sizing agent is used as an external sizing agent, it must be adjusted so that the friction coefficient is in the range of 0.45-0.75. As additional internal sizing agents, there may be used paper making chemical additives such as coloring agents, paper strength enhancers and retention aids, in amounts which do not affect the Stockigt sizing degree or friction coefficient. Paper strength enhancers which may be used include cationic-modified starch, polyacrylamides and the like, while wet paper strength enhancers include polyamidepolyamine epichlorhydrin resins, melamine-formalin resins, urea-formalin resins and the like. However, as the use of wet paper strength enhancers notably impairs the disintegration property, care must be taken when they are used.

Various binder resins may also be used for the purpose of enhancing the surface strength. There may be mentioned water-soluble polymers including starches such as oxidized starch, enzyme-modified starch, cationic-modified starch, ester-modified starch and ether-modified starch, methyl cellulose, ethyl cellulose, carboxymethylcellulose, methoxycellulose, hydroxycellulose, polyvinyl alcohols such as totally (or partially) saponified polyvinyl alcohol, carboxy-modified polyvinyl alcohol or silicon-modified polyvinyl alcohol, polyacrylamide, polyvinylpyrrolidone, acrylic amide, acrylic acid ester copolymers, acrylic amide esters, methacrylic acid copolymers, styrene-maleic anhydride copolymer alkali salts, isobutylene-maleic anhydride copolymer alkali salts, and casein, and latexes such as polyvinyl acetate, polyurethane, polyacrylic acid, polyacrylic acid esters, polybutyl methacrylate, styrene-butadiene copolymers and the like.

There are no particular restrictions on the method for external addition of the aforementioned surface strength enhancers, and it may be accomplished by coating and drying using an on-machine or off-machine coater provided with a coating device such as an air knife coater, roll coater, reverse roll coater, blade coater, bar coater, gravure coater, kiss-roll coater, cast coater, curtain coater, die-slot coater, champlex coater, brush coater, gate-roll coater, Hamilton coater, KCM coater, size-press coater, metered size coater, metered film transfer roll coater, lip coater, slide bead coater or the like.

When a resinous substrate is used as the sheet-form substrate, formation of the sheet may be accomplished by subjecting a cellulose-based starting material such as viscose or acetate, or an organic resin such as polyethylene, polypropylene, polyvinyl chloride, polystyrene, nylon, polycarbonate, polyethylene terephthalate, polybutylene terephthalate or the like, optionally together with a filler or chemical agent, to a publicly known process such as an extrusion process, calender process, drawing process or the like. Synthetic paper or spun-bond nonwoven fabrics may also be used.

According to a preferred embodiment of the invention, an amino group-containing acrylic-based resin is used as the toner fixing enhancer. In a wet electrophotographic electrostatic liquid developing system, following a selective transfer of the liquid toner for electrostatic development described in detail below onto a charged latent image, development is performed. After this, heat treatment with a transfer drum is carried out so as to volatilize the solvent, thereby a film basically composed of the resin contained in the liquid toner, such as a polyolefin-based resin, bonded to the recording sheet is formed. Therefore, adhesion between the toner resin-based film and the recording sheet is primarily based on a physical bonding force generated by fusion of the heat-softened film against the recording sheet. In this situation, using an amino group-containing acrylic-based resin having both a hydrophobic portion (polyethylene) and hydrophilic portion (amino nitrogen) in the same molecule results in crosslinking due to chemical bonding of the hydrophilic portions (amino nitrogens) to the paper substrate composed mainly of cellulose fiber, and fusion/integration of the hydrophobic portions (polyethylene) to the toner resin-based film. This phenomenon produces a powerful adhesive force between the recording sheet and toner resin-based film, and therefore allows notable improvement in the fixing property.

Amino group-containing acrylic-based resins include ones produced by emulsion-polymerising amino group-containing acrylic monomers partially or totally neutralized by means of organic acids, with monomers composed mainly of alkyl (meth)acrylates, in the presence of emulsifiers.

Amino group-containing acrylic monomers are (meth)acrylic acid esters or (meth)acrylamides containing amino groups, and include aminoalkyl (meth)acrylate-based monomers, N-aminoalkyl (meth)acrylamide monomers, and the like.

As specific examples of aminoalkyl (meth)acrylate-based monomers, there may be mentioned dimethylaminoethyl (meth)acrylate, dimethylaminopropyl (meth)acrylate, t-butylaminoethyl (meth)acrylate, monomethylaminoethyl (meth)acrylate, and the like.

As specific examples of N-aminoalkyl (meth)acrylamide monomers, there may be mentioned dimethylaminopropyl (meth)acrylamide, dimethylaminoethyl (meth)acrylamide, and the like.

The amino group-containing acrylic monomer can be partially or totally neutralized with an organic acid, and subjected to emulsion polymerization. Organic carboxylic acids are preferred as organic acids. As examples of organic carboxylic acids, there may be mentioned formic acid (boiling point: 100.8° C.), acetic acid (boiling point: 117.8° C.), propionic acid (boiling point: 140.8° C.), and the like. One or more of such acids may be used.

An alkyl (meth)acrylate is an alkyl ester of (meth)acrylic acid, and it is preferably an alkyl ester of (meth)acrylic acid having an alkyl group of 1-10 carbon atoms. As specific examples, there may be mentioned methyl (meth)acrylate, ethyl (meth)acrylate, butyl (meth)acrylate, 2-ethylhexyl (meth)acrylate, hydroxypropyl (meth)acrylate, β-ethoxyethyl (meth)acrylate, glycidyl (meth)acrylate, and the like. The alkyl group mentioned above may also be a substituted alkyl group.

According to another embodiment of the present invention, at least one resin selected from the group consisting of rosin ester-based resins, styrene/acrylic-based resins, styrene/maleic-based resins, olefin/acrylic-based resins and olefin/maleic-based resins can be used as the toner fixing enhancer. As mentioned above, in the wet electrophotographic electrostatic liquid developing system, following a selective transfer of the liquid toner for electrostatic-development onto a charged latent image, development is performed, after which heat treatment with a transfer drum is carried out so as to volatilize the solvent, thereby a film basically composed of the resin contained in the liquid toner, such as a polyolefin-based resin, bonded to the recording sheet is formed. Therefore, adhesion between the toner resin-based film and the recording sheet is primarily based on a physical bonding force generated by fusion of the heat-softened film against the recording sheet.

When a rosin ester-based resin having both a hydrophobic and a hydrophilic portion is used in this situation, this results in crosslinking due to chemical bonding of the hydrophilic portions to the paper substrate composed mainly of cellulose fiber, and fusion/integration of the hydrophobic portions to the toner resin-based film. Styrene/acrylic-based resins, styrene/maleic-based resins, olefin/acrylic-based resins and olefin/maleic-based resins have the same effect, but because these resins also have an effect of enhancing the penetration of the rosin ester-based resins, they may be used in combination with the rosin ester-based resins to increase cohesion of the toner resin-based film with the recording sheet. This phenomenon produces strong adhesive force between the recording sheet and toner resin-based film, and therefore, allows notable improvement in the fixing property.

According to a preferred embodiment, therefore, the rosin ester-based resin is used in combination with at least one resin selected from the group consisting of styrene/acrylic-based resins, styrene/maleic-based resins, olefin/acrylic-based resins and olefin/maleic-based resins, as the toner fixing enhancer of the invention. In this case, the styrene/acrylic-based resins, styrene/maleic-based resins, olefin/acrylic-based resins or olefin/maleic-based resins may be used alone or in admixture, and are used in a combined amount of 0.1-50 wt %, preferably 1-10 wt % and more preferably 3-5 wt % with respect to the rosin ester-based resin.

Rosin ester-based resins, styrene/acrylic-based resins, styrene/maleic-based resins, olefin/acrylic-based resins and olefin/maleic-based resins are all commonly used as paper making chemicals and exhibit no yellowing with the passage of time, and also provide no difficulty in the disintegration of the collected broke and recycled paper.

The toner fixing enhancer is coated onto at least one side of the sheet-form substrate in an amount of 0.1 g/m² or greater. The coating method is not critical, and any method illustrated above in connection with the method for coating the surface-strength enhancer can be employed, so long as it can efficiently achieve a coating coverage of 0.1 g/m². However, among them, use of a transfer roll coating system can further improve the toner fixing effect of the toner fixing enhancer, because it minimizes penetration of the toner fixing enhancer into the paper substrate and, thereby, provides even coating on the outermost surface of the paper substrate. Transfer roll coating systems include, without being limited, gate roll coater types such as gate roll coaters, Hamilton roll coaters, KCM coaters and the like, as well as Symsizer types such as metered size presses, metered film transfer roll coaters, and the like.

As long as the toner fixing enhancer is located on the surface of the sheet-form substrate, its layer construction or processed form is not critical. For example, it may be coated onto the surface of the sheet-form substrate, or mixed with another substance to be coated onto the sheet-form substrate. Adding it internally during formation of the sheet may also provide the same effect. Thus, the electrophotographic recording sheet of the invention may either be prepared by subjecting at least one side of the sheet-form substrate to a treatment which imparts toner-receiving ability thereto with a treatment composition comprising at least one type of toner fixing enhancer, or by laminating a toner-receiving layer comprising at least one type of toner fixing enhancer on at least one side of the sheet-form substrate. When the toner fixing enhancer is added to the toner receiving layer, it may be added during the coating-preparation stage. Various aforementioned binder resins can be used as the coating binder resins, and various aforementioned fillers can be used as the pigments. The treatment composition or the toner-receiving layer merely needs to comprise the toner fixing enhancer, and will not be affected by the type of binder resin or pigment or the coating method employed. However, in comparison to a situation where it is coated as a clear coating agent on the surface of a woodfree paper substrate or a coated paper, increased amounts of the toner fixing enhancer are required.

A styrene/butadiene-based copolymer (hereinafter also abbreviated as “SB-based copolymer”) is also preferably added to the aforementioned treatment composition or the toner receiving layer containing the toner fixing enhancer. The total of the styrene monomer and butadiene monomer components in the styrene/butadiene-based copolymer is at least 90 mole percent and preferably at least 95 mole percent with respect to 100 mole percent of the copolymer. Such styrene/butadiene-based copolymers are hydrophobic, are fused with the resins used as toners and have an effect of enhancing the toner fixing property.

The coating coverage of the toner fixing enhancer on one surface of the sheet-form substrate is between 0.1 g/m² and 0.8 g/m², and preferably between 0.3 g/m² and 0.5 g/m². If the coating coverage is less than 0.1 g/m², the toner fixing property may be impaired, the print may become faded when rubbed with an eraser, or the printed sections may peel off with cellophane tape that has been attached to toner-fixed image sections, and thus is not preferred. The upper limit of 0.8 g/m² is preferably not exceeded because the coating or internal addition effect becomes saturated, cost is increased, and yellowing of the recording sheet may occur due to amine oxidation when an amino group-containing acrylic-based resin is used.

The toner fixing enhancer of the invention is intended for general paper product use and, when utilized in the ranges specified above, it is possible to avoid the problems of poor disintegration of broke and recycled paper.

The friction coefficient of the electrophotographic recording sheet of the invention is important for ensuring a satisfactory paper traveling property, and it is preferably in the range of 0.40-0.75. At less than 0.40, the recording sheet may undergo excessive slippage, causing double feeding or mis-feeding of the recording sheets. Double feeding or mis-feeding can also occur with a friction coefficient of greater than 0.75. The stiffness of the recording sheet also affects the paper traveling property, and therefore the thickness is preferably 60-230 μm with a Clark stiffness in the CD direction of preferably 13.5-30.0 cm. At less than 13.5 cm, the lack of stiffness can increase the risk of clinging onto the feeding roll or transfer roll of the printing machine, while a stiffness of greater than 30.0 cm is not preferred as this may affect not only the paper throughput but also the quality of the print itself.

The friction coefficient is preferably adjusted by internal or external addition of a lubricant. The lubricant used may be a modified polyolefin-based wax or emulsion, a natural resin, a metallic stearate, or the like. The Clark stiffness is preferably adjusted by varying the density through the calendering process as mentioned above. However, it is also effective to combine this adjustment with adjustment of the press nip pressure applied during the water drainage step in the paper-making process.

The basis weight of the wet electrophotographic liquid toner recording sheet of the invention is preferably 50-220 g/m², and the air permeability (JIS P8117) is preferably no greater than 40 seconds from the standpoint of preventing curling of printed sheets. Suitable recording sheets are sheets having a curl height of no greater than 30 mm in the widthwise direction, a curl height of no greater than 25 mm in the running direction and a twisting curl height of no greater than 20 mm, where the curl heights in the widthwise direction, running direction and with twisting are measured for A4 copy machine-printed sheets suspended in a downward direction. The degree of whiteness is not particularly restricted but is preferably at least 70% in order to yield a clearer printed surface.

There are no particular restrictions on the toner particles in the liquid toner for electrostatic development used as the image-forming material, and those produced by any conventional method can be used. Examples include developers such as those disclosed in Japanese Examined Patent Publication (Kokoku) No. 55-3696, Japanese Unexamined Patent Publication (Kokai) No. 52-125333 and Japanese Unexamined Patent Publication (Kokai) No. 48-49445, which comprise toners composed mainly of pre-milled pigments/dyes and thermoplastic resins dispersed in a toner-dispersing media. Of a similar type are developers such as those described in Japanese Unexamined Patent Publication (Kokai) No. 61-36759, which are obtained by a method comprising adding a small amount of a non-aqueous solvent to a thermoplastic resin and coloring agent, kneading it by kneading means such as a ball mill or high-speed mixer to prepare a concentrated toner, and then dispersing it in the non-aqueous solvent by means of a disperser. A more recent production process has been proposed in Japanese Examined Patent Publication (Kokoku) No. 5-87825. This is a process for producing a liquid developers by first solvating in a non-polar solvent a thermoplastic resin having the property of being insoluble in a non-polar solvent at below 40° C. but solvates in the non-polar solvent at above 50° C., and then cooling the solvate to form fine thermoplastic resin particles. Several different liquid toner production processes have thus been proposed, and there is no limitation to those described above.

The composition of the toner particles in the liquid toner is not critical, and any one of those publicly known in the prior art may be used. Generally, the toner particles comprise a fixing agent for fixing of the toner particles onto the recording sheet, a coloring agent such as a pigment or dye to create visibility, an electric charge imparting agent to impart an electric property to the liquid toner, and the like.

The fixing resin used in the liquid toner for electrostatic development may be any publicly known resin which has been hitherto employed in the prior art as the liquid toner for electrostatic development, but thermoplastic resins are particularly preferred. For example, there may be used polystyrene, polyolefin-based resins such as polyethylene or polypropylene, polyesters, polyurethanes, polyamides and the like, either alone or in admixture. Especially preferred among these are thermoplastic resins containing carboxyl groups, such as polyacrylate, styrene-acrylate copolymer, ethylene-acrylate copolymer and ethylene-methacrylate copolymer, although there is no particular limitation to these resins.

Coloring agents used in the liquid toner for electrostatic charge developing to be used for the invention include publicly known pigments and dyes which have been added to the liquid toners for electrostatic development in the prior art, as well as mixtures thereof. As examples there may be mentioned Hansa yellow, benzidine yellow, benzidine orange, fast red, brilliant carmine 3B, copper phthalocyanine blue, phthalocyanine green, spirit black, oil blue, alkaline blue, rhodamine 6B, nigrosine, carbon black, dichloroquinacridone, isoindolinone, and the like.

A charge modifier may also be added to the liquid toner for electrostatic development used for the present invention. As charge modifers, there may be used any of the publicly known electric charge imparting agents or modifiers, including metal salts of fatty acids such as naphthenic acid, octeic acid, oleic acid, stearic acid and lauric acid, metal salts of sulfosuccinic acid esters, the oil-soluble sulfonic acid metal salts mentioned in Japanese Examined Patent Publication (Kokoku) No. 45-556, the abietic acid or hydrogenated abietic acid metal salts mentioned in Japanese Examined Patent Publication (Kokoku) No. 48-25666, the calcium alkylbenzenesulfonate mentioned in Japanese Examined Patent Publication (Kokoku) No. 55-2620, the aromatic carboxylic acid or sulfonic acid metal salts mentioned in Japanese Unexamined Patent Publication (Kokai) No. 52-107837, non-ionic surfactants such as polyoxyethylated alkylamines, fats and oils such as lecithin and linseed oil, polyvinylpyrrolidone, organic acid esters of polyhydric alcohols, and the like.

The recording sheet for wet electrophotographic liquid toner of the present invention may also be used for postcards, general purpose printing paper (also multicolored), ink-jet paper, ink-jet sheets which require water resistance, business form, dry electrophotographic sheets, heat transfer receiving sheets, laminating base sheet for release paper, and the like.

### EXAMPLES

The present invention will now be explained in further detail based on the following examples, with the understanding that the invention is in no way restricted to the examples. Throughout these examples, “parts” will refer to parts by mass and “%” will refer to percentage by mass.

### Examples 1-4

A pulp consisting of 100% ECF-bleached LBKP (bleached kraft pulp) obtained using eucalyptus and oak as starting materials was beaten to 380 ml CSF, and after adding 10.0 mass % of precipitated calcium carbonate as a filler, 0.07 mass % of alkenyl succinic anhydride (Fibran 81, a product of National Starch & Chemical) as an internal sizing agent and 0.02 mass % of a retention aid (PERCOLL 182, a product of Kyowa Sangyo Co., Ltd.), the blend was made into paper using a Fourdrinier multicylinder paper machine, to prepare a sheet-form substrate with a basis weight of 64.0 g/m² (hereinafter referred to as “base paper”). A gate roll coater was used to coat one side of the base paper with a mixed solution comprising polyvinyl alcohol (PVAK17, a product of Denki Kagaku Kogyo Co., Ltd.) and an amino group-containing acrylic-based resin (RIKABOND ET-8, a product of Chuo Rika) to apply, as the components to impart toner-receiving ability, the polyvinyl alcohol at a coating amount of 0.3 g/cm², and the amino-group containing acrylic-based resin at a coating amount of 0.1 g/m² (Example 1), 0.3 g/m² (Example 2), 0.5 g/m² (Example 3) or 0.8 g/m² (Example 4), and the coating was then dried to obtain an electrophotographic recording sheet.

### Example 5

An electrophotographic recording sheet was obtained in the same manner as in Examples 1-4 using the base paper obtained in Examples 1-4, except that a different amino group-containing acrylic-based resin (ZAIKTHENE AC, a product of Sumitomo Seika Chemicals Co., Ltd.) was applied at a coating amount of 0.3 g/m².

### Example 6

Using the same base paper obtained in Examples 1-4, a gate roll coater was used to coat one side of the base sheet with a mixed solution comprising polyvinyl alcohol (PVAK17, a product of Denki Kagaku Kogyo Co., Ltd.) and a mixture of 97 parts of a rosin ester-based resin (SUPER ESTER E-730-55, a product of Arakawa Chemical Industries, Ltd.) and 3 parts of a styrene/acrylic-based resin (POLYMARON 1308, a product of Arakawa Chemical Industries, Ltd.) to apply, as the components to impart toner-receiving ability, the polyvinylalcohol at a coating amount of 0.3 g/m², and the mixture at a coating amount of 0.3 g/m², and the coating was then dried to obtain an electrophotographic recording sheet.

### Example 7

An electrophotographic recording sheet was obtained in the same manner as in Example 6 using the base paper obtained in Examples 1-4, except that a mixture of 95 parts of a rosin ester-based resin (SUPER ESTER E-650, a product of Arakawa Chemical Industries, Ltd.) and 5 parts of a styrene/maleic-based resin (POLYMARON 385, a product of Arakawa Chemical Industries, Ltd.) was applied at a coating amount of 0.3 g/m².

### Example 8

An electrophotographic recording sheet was obtained in the same manner as in Example 6 using the base paper obtained in Examples 1-4, except that a mixture of 95 parts of a rosin ester-based resin (SUPER ESTER E-650, a product of Arakawa Chemical Industries, Ltd.) and 5 parts of an olefin/maleic acid-based resin (POLYMARON 482S, a product of Arakawa Chemical Industries, Ltd.) was applied at a coating amount of 0.3 g/m².

### Example 9

An electrophotographic recording sheet was obtained in the same manner as in Examples 1-4 using the base paper obtained in Examples 1-4, except that a double-roll size press impregnating machine was used for impregnation of the polyvinyl alcohol (PVAK17, a product of Denki Kagaku Kogyo Co., Ltd.) at 0.6 g/m² and the amino group-containing acrylic-based resin (RIKABOND ET-8, a product of Chuo Rika) at 0.6 g/m².

### Example 10

An electrophotographic recording sheet was obtained in the same manner as in Examples 1-4 using the base paper obtained in Examples 1-4, except that a double-roll size press impregnating machine was used for impregnation of the polyvinyl alcohol (PVAK17, a product of Denki Kagaku Kogyo Co., Ltd.) at 0.6 g/m² and the mixture of 97 parts of a rosin ester-based resin (SUPER ESTER E-730-55, a product of Arakawa Chemical Industries, Ltd.) and 3 parts of a styrene/acrylic-based resin (POLYMARON 1308, a product of Arakawa Chemical Industries, Ltd.) at 0.6 μm².

### Example 11

A roll coater was used to coat one side of 81.4 g/m² mat coated paper (NEW AGE, a product of Oji Paper Co., Ltd.) as the base paper, with a mixed solution comprising polyvinyl alcohol (PVAK17, a product of Denki Kagaku Kogyo Co., Ltd.) and an amino group-containing acrylic-based resin (RIKABOND ET-8, a product of Chuo Rika), to apply, as the components to impart toner-receiving ability, the polyvinyl alcohol at a coating amount of 0.3 g/m², and the amino group-containing acrylic-based resin at a coating amount of 0.3 g/m², and the coating was then dried to obtain an electrophotographic recording sheet.

### Example 12

A gate roll coater was used to coat one side of the base paper obtained in Examples 1-4 with a mixed solution comprising an SB-based copolymer (POT7192, a product of Nihon Zeon Co., Ltd.) and an amino group-containing acrylic-based resin (RIKABOND ET-8, a product of Chuo Rika), to apply, as the components to impart toner-receiving ability, the SB-base copolymer at a coating amount of 0.3/m², and the amino group-containing acrylic-base resin at a coating amount of 0.3 g/m², and the coating was then dried to obtain an electrophotographic recording sheet.

### Example 13

A gate roll coater was used to coat one side of the base paper obtained in Examples 1-4 with a mixed solution comprising a mixture of 50 parts of an SB-based copolymer (PA3056, a product of Nihon A&L) and 50 parts of polyvinyl alcohol (PVAK17, a product of Denki Kagaku Kogyo Co., Ltd.) and an amino group-containing acrylic resin (RIKABOND ET-8, a product of Chuo Rika), to apply, as the components to impart toner-receiving ability, the mixture at a coating amount of 0.3 g/m², and the amino group-containing acrylic resin at a coating amount of 0.3 g/m², and the coating was then dried to obtain an electrophotographic recording sheet.

### Example 14

[Preparation of Primer Coating Mixture]

After adding 0.2 part of sodium polyacrylate (ARON A-9, a product of To a Gosei Chemical Co., Ltd.) as a dispersing agent to 25 parts of precipitated calcium carbonate (TAMAPERL TP121, a product of Okutama Kogyo Co., Ltd.) and 75 parts of ground calcium carbonate (SOFTON 2200, a product of Bihoku Funka Kogyo Co., Ltd.) used as pigments, a Cowles disperser was used to prepare a pigment slurry with a solid concentration of 70%. This was followed by addition of 10 parts of oxidized starch (ACE A, a product of Oji Corn Starch, Japan) and 10 parts of an SB-based copolymer (PT1004, a product of Nihon Zeon) (both in terms of solid basis) to the slurry, and then further addition of water to prepare a coating material with a solid concentration of 62%.

[Top Coating Mixture]

After adding 0.2 part of sodium polyacrylate (ARON A-9, a product of To a Gosei Chemical Co., Ltd.) as a dispersing agent to 50 parts of kaolin (AMAZON, a product of Cadam Co.) and 50 parts of precipitated calcium carbonate (TAMAPEARL TP121, a product of Okutama Kogyo Co., Ltd.) used as pigments, a Cowles disperser was used to prepare a pigment slurry with a solid concentration of 70%. This was followed by addition of 5 parts of oxidized starch (ACE A, a product of Oji Corn Starch, Japan) and 15 parts of an SB-based copolymer (PT1004, a product of Nihon Zeon) (both in terms of solid basis) to the slurry, and then further addition of 10 parts of an amino group-containing acrylic-based resin (RIKABOND ET-8, a product of Chuo Rika) and water to prepare a coating material with a solid concentration of 60%.

A rod coater was used to coat one side of the base paper obtained in Examples 1-4 with the primer coating mixture to a dry weight of 15 g/m², and then after drying, the rod coater was used for coating of the top coating mixture to a dry weight of 10 g/m². This was subsequently dried to obtain an electrophotographic recording sheet.

### Comparative Example 1

A gate roll coater was used to coat both sides of the base paper obtained in Examples 1-4 with a mixed solution comprising polyvinyl alcohol (PVAK17, a product of Denki Kagaku Kogyo Co., Ltd.) and a polyethyleneimine-based resin (EPOMINE p1000, a product of Nihon Shokubai Kagaku Co., Ltd.), to apply, as the components to impart toner-receiving ability, the polyvinyl alcohol at a coating amount of 0.3 g/m², and the polyethyleneimine-based resin at a coating amount of 0.3 g/m² on each side, and the coatings on both sides were then dried to obtain an electrophotographic recording sheet.

### Comparative Example 2

An electrophotographic recording sheet was obtained without coating an amino group-containing acrylic-based resin on the base paper obtained in Examples 1-4.

### Comparative Example 3

An electrophotographic recording sheet was obtained without coating an amino group-containing acrylic-based resin on the mat coated paper used in Example 11.

Table 1 shows the results of evaluating the properties of the electrophotographic recording sheets obtained in Examples 1-14 and Comparative Examples 1-3, as described below.

(Printing Suitability)

(Printing Density)

A wet electrophotographic copying machine (E-PRINT 1000, Indigo) was used for image output. The reflection density of the black solid sections of the obtained image was measured using a reflection densitometer (MACBETH RZ-918, a product of Macbeth Co.)

(Cellophane Tape Release Test)

Cellophane tape (CELLOTAPE®, a product of Nichiban Co., Ltd.) was attached to a black solid printed section and then peeled off, and the status of the printed section was evaluated.

(Eraser Resistance Test)

Character-printed sections were rubbed 20 times with an erasser (PE-04A, a product of Tonbo Pencil, Japan) and the status of the print was observed.

(Visual Evaluation of Yellowing)

The test piece was placed in a hot-air circulating oven at 105° C. and allowed to stand for 24 hours, after which the status of yellowing was observed.

TABLE 1

| | | Macbeth | Cellophane | | |
|---|---|---|---|---|---|
| | | reflection | tape | Eraser | |
| | | density | release | resistance | Yellowing |
| Example | 1 | 1.56 | ◯ | ◯ | ⊚ |
| | 2 | 1.59 | ⊚ | ⊚ | ⊚ |
| | 3 | 1.60 | ⊚ | ⊚ | ◯ |
| | 4 | 1.60 | ⊚ | ⊚ | ◯ |
| | 5 | 1.57 | ⊚ | ⊚ | ◯ |
| | 6 | 1.58 | ◯ | ◯ | ⊚ |
| | 7 | 1.58 | ⊚ | ⊚ | ◯ |
| | 8 | 1.57 | ⊚ | ⊚ | ◯ |
| | 9 | 1.55 | ◯ | ◯ | ⊚ |
| | 10 | 1.57 | ◯ | ◯ | ◯ |
| | 11 | 1.60 | ◯ | ⊚ | ◯ |
| | 12 | 1.63 | ◯ | ◯ | ⊚ |
| | 13 | 1.58 | ⊚ | ⊚ | ⊚ |
| | 14 | 1.57 | ⊚ | ⊚ | ⊚ |
| Comp. Ex. | 1 | 1.58 | ⊚ | ⊚ | X |
| | 2 | 1.44 | X | X | ⊚ |
| | 3 | 1.50 | X | X | ⊚ |

⊚ absolutely no status change observed
◯ no significant status change observed
Δ a little status change observed
X status change observed

It will be appreciated by those skilled in the art that, while the invention has been described above in connection with particular embodiments and examples, the invention is not necessarily so limited and that numerous other embodiments, examples, uses, modifications and departures from the embodiments, examples and use may be made without departing from the inventive scope of this application.

What is claimed is:

1. An electrophotographic recording sheet comprising a sheet-form substrate, at least one surface of said substrate having been subjected to a treatment so as to impart a toner-receiving ability thereto, characterized in that said treatment is carried out with a treatment composition comprising at least one resin selected from the group consisting of amino group-containing acrylic-based resins, rosin ester-based resins, styrene/acrylic-based resins, styrene/maleic-based resins, olefin/acrylic-based resins and olefin/maleic-based resins.

2. The electrophotographic recording sheet according to claim 1, wherein said treatment composition comprises at least an amino group-containing acrylic-based resin.

3. The electrophotographic recording sheet according to claim 1, wherein said treatment composition comprises at least a rosin ester-based resin.

4. The electrophotographic recording sheet according to claim 3, wherein said treatment composition comprises a rosin ester-based resin in combination with at least one resin selected from the group consisting of styrene/acrylic-based resins, styrene/maleic-based resins, olefin/acrylic-based resins and olefin/maleic-based resins.

5. The electrophotographic recording sheet according to claim 1, wherein said treatment composition further comprises a styrene/butadiene-based copolymer.

6. An electrophotographic recording sheet comprising a sheet-form substrate and a toner-receiving layer on at least one surface thereof, characterized in that said toner-receiving layer comprises at least one resin selected from the group consisting of amino group containing acrylic-based resins, rosin ester-based resins, styrene/acrylic-based resins, styrene/maleic-based resins, olefin/acrylic-based resins and olefin/maleic-based resins.

7. The electrophotographic recording sheet according to claim 6, wherein said toner-receiving layer comprises at least an amino group-containing acrylic-based resin.

8. The electrophotographic recording sheet according to claim 6, wherein said toner-receiving layer comprises at least a rosin ester-based resin.

9. The electrophotographic recording sheet according to claim 8, wherein said toner-receiving layer comprises a rosin ester-based resin in combination with at least one resin selected from the group consisting of styrene/acrylic-based resins, styrene/maleic-based resins, olefin/acrylic-based resins and olefin/maleic-based resins.

10. The electrophotographic recording sheet according to claim 6, wherein said toner-receiving layer further comprises a styrene/butadiene-based copolymer.
